(19) United States
(12) Patent Application Publication
(10) Pub. No.: US 2013/0299314 A1
(43) Pub. Date: Nov. 14, 2013

(54) Compacting conveyor belt particularly for the feed of pyrolysis, gasification and combustion plants

(71) Applicant: Enzo Morandi, Casole d'Elsa (SI) (IT)

(72) Inventor: Enzo Morandi, Casole d'Elsa (SI) (IT)

(73) Assignee: NSE INDUSTRY S.P.A., Empoli (FI) (IT)

(21) Appl. No.: 13/825,818

(22) PCT Filed: Oct. 8, 2010
(86) PCT No.: PCT/IT10/00417

§ 371 Date: Mar. 23, 2013

(51) Int. Cl. B65G 47/22; B65G 37/00

(52) U.S. Cl. CPC B65G 47/22; B65G 37/005
USPC 198/604

(57) ABSTRACT

The present invention concerns a device (1) for the transport and compaction of material, preferably of combustible material destined to the feed of plants for energy production. The device includes a pressing belt (2) overlapped to a conveyor belt (3) according to a certain angle of incidence in such a way as to define such a convergent advancement path (4) as to compact the material during its advancing motion. A first (9) and a second (10) bulkhead are arranged in such a way as to contain into the advancement path (4) the material comprised between the belts. In accordance with the invention, the first bulkhead (9) and the second bulkhead (10) result to be mobile integrally at least with respect to the conveyor belt (3) and arranged at such a reciprocal distance d that the superior belt (2) results to be insertable into the space (11) comprised between the bulkheads (9, 10) in such a way as to compact the material contained into the space (11).

### TECHNICAL FIELD

The present invention refers to the technical field of the devices for the transport of materials in general and contextual compaction of them, particularly waste and/or combustible material for the feed of energy production plants.

In particular, the invention refers to an innovative type of conveyor/compaction belt particularly functional and of high efficiency.

### BACKGROUND ART

The use of conveyor belts for the transport of material along a production path, also in technical fields very different from each other, has long been known.

An example is the case in which the material must be fed to recycling or energy production plants, such as gasificators or waste disposal plants. It is in fact known that in the technical field relative to the energy production plants, through the combustion of waste and/or combustible material in general, heat, and therefore energy, can be produced. In that sense, on the basis of the specific plant in use, feeders of different nature are used, for example conveyor belts, pushers or Archimedean screws, which feed the material towards the treatment areas.

Nevertheless, it is often necessary to realize, simultaneously to the transport of the material, the compaction of it in order to reduce its overall volume and cause the exit of air and/or liquids eventually trapped and that can somehow invalidate the subsequent industrial process (for example combustion).

To that aim, it is known, for example, the use of conveyor belts which generally include two belts arranged one opposite to the other in such a way as to define a feeding channel which is reduced in its section progressively (therefore of converging type). This is generally obtained arranging two or more than two belts according to a predetermined reciprocal inclination angle (for example a superior pressing belt inclined with respect to the inferior conveyor belt placed horizontally). In that sense, the material that advances on the horizontal belt is pressed by the superior pressing belt due to the convergency.

In order to compact the transported material efficiently, therefore, and to avoid lateral overflows of it due to the pressing, bulkheads are generally arranged which delimit laterally the conveyor belts. The bulkheads are arranged in such a way as to be fixed to the ground so that they result to be immobile with respect to the advancing motion of the belts themselves.

It is evident that such a solution is not free from diverse technical problems that invalidate the efficiency and functionality of the whole system.

It is in fact evident that, precisely because of the pressing due to the convergency of the path, the material that advances tends at the same time to press always with a higher pressure against the lateral containment walls. Being the bulkheads absolutely fixed, that is immobile with respect to the advancing motion of the belt, a strong friction between the material in pressing and the bulkheads themselves is therefore generated. In addition, such friction increases considerably when the degree of compaction increases to such a point as to be able to trigger serious malfunctioning phenomena, such as the slowing down or even the block of the advancement for the material. This is therefore the cause of an effort overload for the engines of the belts as well as an overload on the whole supporting structure of the belts themselves; typically the tracks.

In other cases, the block of the material could cause the skidding of the belts with respect to the material itself comprised between them which, in this manner, remains stuck.

It is therefore evident that in such situations problems of noise and wear of the parts can arise, with the consequent increase in the maintenance costs. Moreover, a considerable slowing down for the whole production process downstream the belts results inevitable.

### Disclosure of invention

It is therefore the aim of the present invention to provide a device for the transport and compaction of material, preferably to feed plants of combustion for the energetic production, such as gasificators, pyrolysis plants and/or combustion plants that solves at least in part the said technical problems.

It is therefore the aim of the present invention to provide a device for the transport and compaction that reduces to the minimum the effects of wear and noise of it during the functioning.

In particular, it is the aim of the invention to provide a constructive solution of a device for the transport and compaction wherein, even if a containment element is present to avoid the overflow of the pressed material, it does not interfere with the advancement of the material itself, thus reducing to the minimum or even eliminating completely the effects of friction by slipping of the material with respect to the said containment bulkheads.

It is therefore the aim of the present invention to provide a device for transport wherein, even if a compaction phase is present, the advancement of the material takes place without an excessive overload on the engines or on the whole supporting structure.

These and other aims are therefore obtained through the present device 1 for the transport and compaction of material 15, as per claim 1.

Through an appropriate predisposition of at least a first conveyor belt 2 and at least a second conveyor belt 3 one opposite to the other, a feeding channel 4 is realized for the material 15 of the convergent type. In such a manner, the material comprised between the belts suffers a progressive compaction during its advancement.

A first 9 and a second bulkhead 10 are therefore arranged in order to contain into the said channel 4 the material comprised between the belts and thus avoid its overflow after the pressing.

In order to eliminate completely the risk of block due to the relative slipping of the material 15 transported with respect to the containment bulkheads, the first bulkhead 9 and the second bulkhead 10 are arranged in such a way as to result to be mobile in a substantially integral manner to at least one of the two belts. In accordance with such a solution, a containment seat 11 of the material is therefore created, which moves integrally to the belts.

In accordance with such a solution, the material and the bulkheads now move at the same speed, or, equivalently, with a relative speed substantially null between them. In such a manner, the friction effect of the material results to be significantly reduced or completely eliminated, eliminating completely the risk of block or overloads of the engines.

Advantageously, the conveyor belt (2) is a pressing belt (2) and is overlapped to the conveyor belt (3) according to a predetermined angle of incidence (α), the bulkheads being arranged in such a way as to result to be mobile integrally to the said conveyor belt (3).

Advantageously, the conveyor belt (3) includes a plurality of sliding blocks (7), each sliding block comprising on its sides a pair of the said bulkheads (9, 10) arranged at a reciprocal distance (d) in such a way as to define a seat (11) of containment of the material (15) that moves integrally to the sliding block.

Advantageously, connection means are included for connecting in a fixed manner the bulkheads (9, 10) to each sliding block (7).

Advantageously, the said connection means can be such that the bulkheads (9, 10) result to be connectable to the sliding block at different distances (d) that are adjustable so as to render the dimension of the seat (11) variable.

Alternatively, the sliding block comprising the bulkheads (9, 10) can be realized in a single piece by fusion or moulding.

Advantageously, in all the cases described, the reciprocal distance (d) between the bulkheads must be such that the pressing belt (2) results to be insertable inside the space (11) comprised between the bulkheads (9, 10) so as to compact the material contained during the advancement.

Advantageously, the first (9) and the second bulkhead (10) can include respectively a step (12) so as to define an inferior compaction area (14) and a superior transport area (13) for the material.

Advantageously, the sliding block (7) comprising the bulkheads is substantially U-shaped.

Advantageously, the pressing belt (2) and the conveyor belt (3) are closed-loop belts that rotate at the same speed.

It is also described here a method for modifying a device (1) as described and comprising the operation of connection of a plurality of bulkheads (9, 10) in an integral manner to the two edges of the inferior belt (3) so that the bulkheads move in an integral manner to the said belt (3), reducing the slipping friction between the bulkheads and the material contained.

It is described here as well a gasification and/or pyrolysis and/or combustion plant characterized in that it includes a device (1) as described.

It is also described here a conveyor belt (3) that can be coupled in use to a pressing belt (2), which can be overlapped to it according to a certain angle of incidence (α) in such a way as to define a convergent feeding channel (4) into which the material (15) can be compacted during the advancement, the conveyor belt (3) comprising a plurality of sliding blocks (7) arranged in succession.

In accordance with the invention, each sliding block (7) includes a first bulkhead (9) and a second bulkhead (10) arranged distanced from each other in such a manner as to define a seat (11) of containment for the material (15) integral to the sliding block itself so as to reduce in use, during the pressing, the slipping friction between the material that advances and the said bulkheads.

Last, it is described here a sliding block (7) for a conveyor belt (3) as described above and provided with a first (9) and a second bulkhead (10) arranged in such a manner as to define a seat (11) of containment for the material (15) integral to the sliding block itself so as to reduce in use, during the pressing, the slipping friction between the material that advances and the bulkheads.

### BRIEF DESCRIPTION OF DRAWINGS

Further features and advantages of the invention will result clearer with the description that follows of some embodiments, made to illustrate but not to limit, with reference to the annexed drawings, wherein:

FIG. 1 describes a lateral overall view of the present device 1 for the transport and compaction of material 15 in accordance with the invention;

FIG. 2 schematizes a portion of pressing belt 2 wherein two sliding blocks 7′ are highlighted;

FIG. 3 shows a portion of inferior belt 3 that highlights two sliding blocks 7 provided with a bulkhead (8, 9) in accordance with the invention;

FIG. 4 shows an axonometric view of a sliding block 7 in accordance with a first possible embodiment of the invention;

FIG. 5 schematizes in section the pressing operation;

FIGS. from 6 to 8 show a sequence of pressing phases of the material 15 in accordance with the invention.

### DESCRIPTION OF SOME PREFERRED EMBODIMENTS

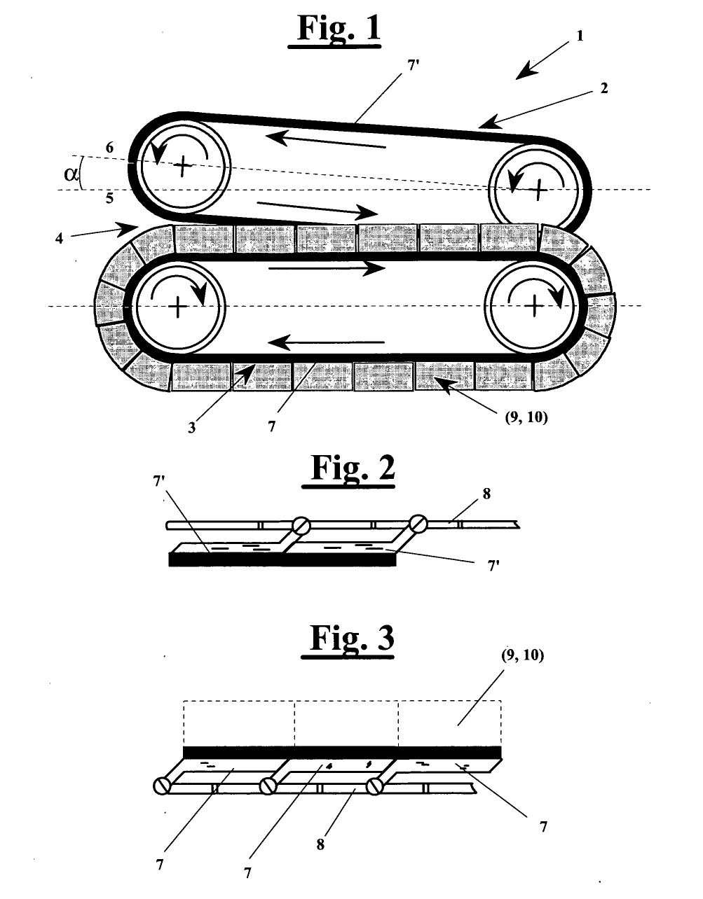

With reference to FIG. 1 the present device 1 for the transport and compaction of material in accordance with the invention is described in a lateral view.

The figure in question shows a first conveyor belt 2 and a second conveyor belt 3 arranged in an overlapped manner one to each other. In particular, the superior belt 2 has the function of pressing belt 2 since it is arranged over the conveyor belt 3, in such a manner as to obtain a feeding channel 4 of the material of the convergent type.

The pressing belt 2 is therefore arranged according to a certain angle of incidence a with respect to the underlying belt 3. The inferior conveyor belt 3 is on the other hand generally arranged in a substantially horizontal manner precisely to allow to support and transport easily the material avoiding that it rolls or overflows outside it. In such a manner, the advancement material along the channel 4 leans on the belt 3 and is progressively pressed by the pressing belt 2 during the advancement.

It is also possible to foresee an adjustment of incidence α (angle comprised between the axis 5 and 6) in such a way as to vary at will, that is increase or diminish, the convergency of the path.

Alternatively, it would be possible to realize the pressing belt 2 in two parts hinged one to each other in such a way that the first part of the belt 2 (the part where the material 4 is inserted) has a certain convergency α with respect to the belt 3 while the tail part of the belt 2 (that is the part of exit of the pressed material) results arranged in parallel to the underlying belt 3.

Such a solution renders the pressing better and stabilizes the structure better.

Always with reference to FIG. 1, in accordance with the invention, the lateral view highlights a bulkhead which is arranged in such a way as to result to be integral to the inferior belt 3. The bulkhead therefore moves integrally to the belt at the same speed of it. The bulkheads are naturally two, that is one for each side of the conveyor belt 3, but FIG. 1, being a lateral view, highlights only the one arranged on the side in sight.

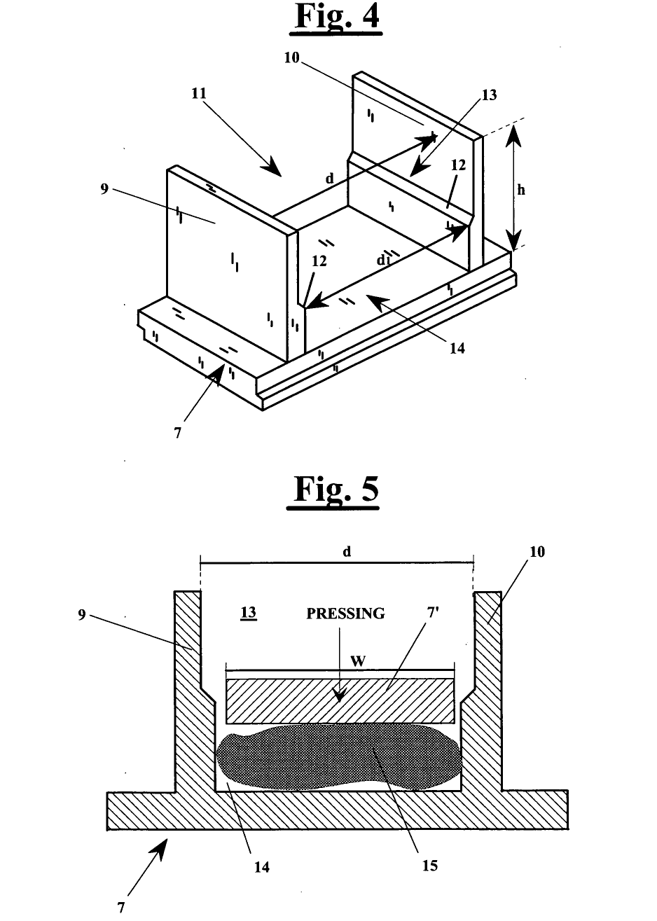

In accordance with a first possible embodiment of the invention, therefore, (see for that purpose FIG. 4), each sliding block 7 of the inferior belt 3 includes a first bulkhead 9 and a second bulkhead 10 arranged fixed on the sliding block itself and distanced one from the other of a certain distance d in such a way as to generate a seat 11 of containment for the material. The height h of the bulkheads is variable and is chosen on the basis of the quantity of material to be compacted (for example bulkheads with a height of about 35 cm can be used).

From what has been described in FIG. 4, it is therefore evident that sliding blocks 7 can be realized wherein the connection of the bulkheads is obtained through screws, bolts, nails or equivalent ordinary connection means. Connection means can be included as well that allow to connect the two bulkheads also at different distances d one from the other, in such a way as to render the dimension of the seat 11 variable.

Alternatively, the sliding block can be realized comprising the bulkheads in a single piece, for example by moulding or fusion.

In all the cases, the bulkheads are integral to the sliding block and must also be dimensioned in such a way as to resist to the thrust pressure of the material contained between them after the pressing.

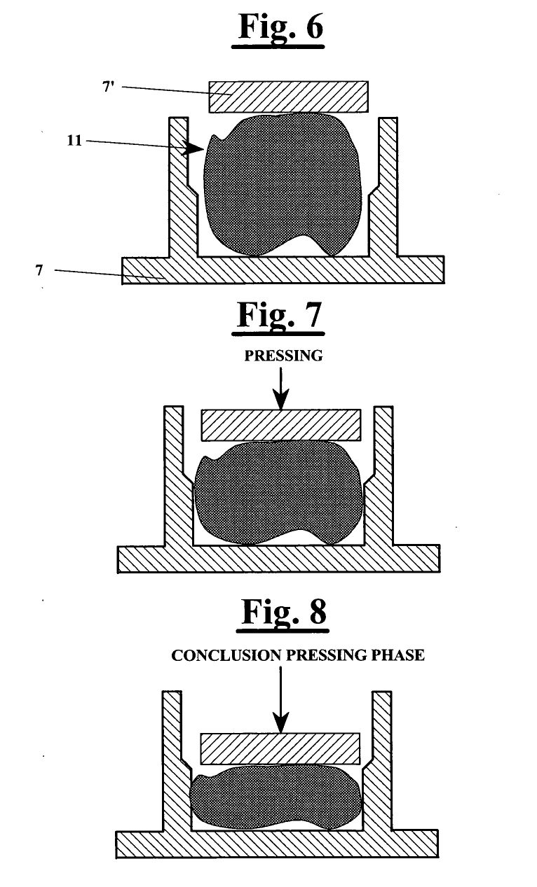

Going into the descriptive detail of the bulkheads (see always FIG. 4 and FIG. 5), they include a step 12 by which a transport area 13 is realized of a width d and arranged superiorly to the step 12 and an inferior compaction area 14 of a width d1 minor with respect to d. The area 14 results to be arranged below the step 12.

In accordance with what has been described, the sliding blocks 7′ of the pressing belt 2, generally but not necessarily flat, will therefore be configured in such a way as to be able to be inserted in use into the seat 11 defined by the bulkheads in question.

In that sense, at least the width d between the bulkheads 9 and 10 of the sliding block 7 must result greater with respect to the overall width W of the sliding block 7′. The FIG. 5 shows, in a frontal view, a pressing phase.

Preferably, the width of the superior sliding block 7′ must be inferior to the width d1.

In a possible variation of the invention the bulkheads are elements separate from the sliding blocks and are directly connected to the transport tracks 8 of the belts (or integrated to them in a single piece). In such a case, it can be for example used again FIG. 1 wherein the bulkheads represented with the numbers 9 and are substituted with equivalent bulkheads connected directly to the tracks 8 for dragging the sliding blocks 7.

In a further variation, the bulkheads can instead be part of an external and independent device which is however placed beside the belts to function as containment. In such a case, a speed programming is included so that the tracks that drag the bulkheads will therefore move at a substantially equal speed to the one of the belts.

FIG. 2, for greater clarity, shows a portion of the pressing belt 2 formed by the dragging tracks 8 to which the sliding blocks 7′ are connected. FIG. 3 shows the inferior belt 3 with the sliding blocks 7 provided with bulkheads integrated to them and designed with a dotted line to better distinguish them from the sliding block itself.

The belts (2, 3) are then activated, as it is well known, by motorized dented wheels in permanent engagement with the tracks 8.

Having described the invention in its basic technical aspects, we now pass onto a description of its functioning.

In virtue of the convergency of the feeding channel 4, the material 15, arranged on the belt 3 and trapped between the inferior belt 3 and the superior pressing belt 2, is pressed during its advancement. In that sense, the width d of predisposition of the bulkheads on the sliding blocks 7 of the inferior belt 3 must be such as to allow the progressive insertion of the sliding blocks 7′ into the underlying seat 11.

FIGS. from 6 to 8 therefore show in succession three progressive sequences of insertion of a sliding block 7′, making part of the pressing belt 2, into the seat 11 of the inferior sliding block 7 where the material is contained. The bulkheads, directly fixed on the sliding block in the example of the figure, will now move in an integral manner to the sliding block itself. In this manner, during all the pressing phase, the slipping friction between material and bulkheads is eliminated completely, rendering the whole process very efficient. The pressed material is therefore impeded to overflow thanks to the presence of the bulkheads (9, 10) without creating any inconvenience of friction or block.

Although it seems preferable to put the two belts (2, 3) between them in phase so as to move at the same speed and thus avoid relative slipping phenomena of the material and the belts, it is anyway also possible to foresee different speeds for them.

The belt can then feed the material, for example combustible material, at any gasificator or plant in general for the production of heat or energy.

Moreover, although preferably described an application for the feed of energy production plants, it is evident that the same device can be used also just for the wringing of humid materials, such as the wringing of bottoms and sludge.

1. A device (1) for the transport and compaction of material (15), preferably for the feed of a gasification and/or pyrolysis and/or combustion plant, and comprising:
At least a first conveyor belt (2) and at least a second conveyor belt (3) one opposite to the other in such a way as to define a convergent feeding channel (4) into which the material (15) is compacted during the advancement;
At least a first bulkhead (9) and at least a second bulkhead (10) of containment for the material and arranged in such a way as to contain into the feeding channel (4) the material comprised between the belts (2, 3);
and characterized in that the said first bulkhead (9) and the said second bulkhead (10) are arranged in such a way as to result to be mobile, along the direction of advancement of the belts, in a substantially integral manner to at least one of the said two belts so as to reduce the slipping friction between the transported material and the containment bulkheads.

2. A device (1), according to claim 1, wherein the conveyor belt (2) is a pressing belt (2) and is overlapped to the conveyor belt (3) according to a predetermined angle of incidence (α), the bulkheads being arranged in such a way as to result to be mobile integrally to the said conveyor belt (3).

3. A device (1), according to claim 1 or 2, wherein the conveyor belt (3) includes a plurality of sliding blocks (7), each sliding block comprising on its sides a pair of bulkheads (9, 10) arranged at a reciprocal distance (d) so as to define a seat (11) of containment for the material (15) that moves integrally to the sliding block.

4. A device (1), according to claim 3, wherein connection means are included to connect in a fixed manner the bulkheads (9, 10) to each sliding block (7).

5. A device (1), according to claim 4, wherein the said bulkheads (9, 10) are connectable to the sliding block at different distances (d) that are adjustable in such a way as to render the dimension of the seat (11) variable.

6. A device (1), according to claim 3, wherein the sliding block comprising the bulkheads (9, 10) is realized in a single piece by fusion or moulding.

7. A device (1), according to one or more of the preceding claims, wherein the reciprocal distance (d) between the bulkheads is such that the pressing belt (2) results to be insertable inside the space (11) comprised between the bulkheads (9, 10) in such a way as to compact the material contained during the advancement.

8. A device (1), according to one or more of the preceding claims from 1 to 7, wherein the said first (9) and the said second bulkhead (10) include respectively a step (12) in such a way as to define an inferior compaction area (14) and a superior transport area (13) for the material.

9. A device (1), according to one or more of the preceding claims from 3 to 8, wherein the said sliding block (7) comprising the bulkheads is substantially U-shaped.

10. A device (1), according to one or more of the preceding claims from 2 to 9, wherein the pressing belt (2) and the conveyor belt (3) are closed-loop belts that rotate at the same speed.

11. A gasification and/or pyrolysis and/or combustion plant characterized in that it includes a device (1), as per one or more of the preceding claims from 1 to 10.

12. A method for modifying a device (1) for the transport and compaction of material, preferably for the feed of a gasification and/or pyrolysis and/or combustion plant, the said device comprising at least a conveyor belt (3) and a pressing belt (2) overlapped to the conveyor belt in such a way as to define a feeding convergent channel (4) for compacting the material (15) comprised between the belts (2, 3) simultaneously to the advancement, the said method comprising the operation of connecting a plurality of bulkheads (9, 10) in an integral manner to the two edges of the inferior belt (3) in such a way that the bulkheads move in an integral manner to the said belt (3), reducing the slipping friction between the bulkheads and the material contained.

13. A conveyor belt (3) that can be coupled in use to a pressing belt (2) that can be overlapped to it according to an angle of incidence (α) in such a way as to define a convergent feeding channel (4) into which the material (15) can be compacted during the advancement, the conveyor belt (3) comprising a plurality of sliding blocks (7) arranged in succession;
and characterized in that each sliding block (7) includes a first bulkhead (9) and a second bulkhead (10) arranged distanced one from the other in such a manner as to define a seat (11) of containment for the material (15) integral to the sliding block itself so as to reduce in use, during the pressing, the slipping friction between the material that advances and the said bulkheads.

14. A sliding block (7) for a conveyor belt (3) that can be coupled in use to a pressing belt (2) opposite to it in such a way as to form a convergent feeding channel into which the material (15) that advances is pressed and characterized in that the said sliding block (7) is provided with a first (9) and a second bulkhead (10) arranged distanced one from the other so as to define a seat (11) of containment for the material (15) integral to the sliding block itself so as to reduce in use, during the pressing, the slipping friction between the material that advances and the said bulkheads.
